(19) United States
(12) Patent Application Publication
(10) Pub. No.: US 2026/0292621 A1
(43) Pub. Date: Sep. 24, 2026

(54) RANDOM ACCESS CHANNEL-LESS PROCEDURE FOR MOBILE INTEGRATED ACCESS AND BACKHAUL

(71) Applicant: Telefonaktiebolaget LM Ericsson (publ), Stockholm (SE)

(72) Inventors: Antonino ORSINO, Kirkkonummi (FI); Ritesh SHREEVASTAV, Upplands Väsby (SE)

(73) Assignee: Telefonaktiebolaget LM Ericsson (publ), Stockholm (SE)

(21) Appl. No.: 19/473,445

(22) PCT Filed: Apr. 2, 2024
(86) PCT No.: PCT/IB2024/053196

§ 371 Date: Oct. 7, 2025

Related U.S. Application Data
(60) Provisional application No. 63/457,955, filed on Apr. 7, 2023.

(51) Int. Cl. H04W 36/00; H04W 36/08

(52) U.S. Cl. CPC H04W 36/00725; H04W 36/08

(57) ABSTRACT

A method performed by a user equipment, UE, for performing handover including receiving a handover command from a network and determining whether a random access channel, RACH-less criteria is satisfied. The method further includes initiating RACH-less handover a target cell based on when the RACH-less criteria is satisfied, else, initiating RACH based handover to the target cell based on when the RACH-less criteria is not satisfied.

### TECHNICAL FIELD

The present disclosure relates generally to communications, and more particularly to communication methods and related devices and nodes supporting wireless communications.

### BACKGROUND

A Mobile Integrated Access and Backhaul (IAB) node is a type of device used in wireless communication networks to provide both access and backhaul functions in a mobile unit.

RACH handover is a wireless telecommunications procedure that allows a user equipment (UE) to handover from one cell to another without losing the connection to the network. In a conventional handover procedure, the UE sends a request to the new cell on the RACH channel to initiate the handover process. However, in RACH-less handover, UE does not need to send a request on the RACH channel to initiate the handover process. Instead, the network initiates the handover process based on the measurement reports received from the UE.

RACH-less handover is particularly useful in scenarios where the RACH channel is congested or the UE is experiencing poor signal quality. In these scenarios, RACH-less handover can help to reduce call setup times and improve the overall performance of the network.

Timing advance (TA) maintenance refers to a mechanism used to maintain the correct timing alignment between the base station (BS) and the UEs in the network.

Mobile Integrated Access and Backhaul is now discussed herein.

IAB technology allows operators to use wireless nodes to expand the coverage area of their existing network and also to add capacity to the network in areas where it is needed most. This is achieved by using the wireless nodes to act as both access points and backhaul (BH) links, which means that they can provide connectivity to users and also transmit data back to the core network. The initial use cases for mobile-IAB/VMR (vehicle mounted relay) are expected to be based on 3rd Generation Partnership Project (3GPP) TR 22.839 V18.1.0 (2021 December).

One of the main use cases of mobile IAB cell is to serve the UEs which are residing in the vehicle with the vehicle mounted relay. Other relevant use cases for mobile IABs involves a mobile/nomadic IAB network node mounted on a vehicle that provides extended coverage. This involves scenarios where additional coverage is required during special events like concerts, or during disasters. The nomadic IAB node provides access to surrounding UEs while the backhaul traffic from the nomadic IAB node is then transmitted wirelessly either with the help of IAB donors or non-terrestrial networks (NTN). A nomadic IAB node also reduces or even eliminates signal strength loss due to vehicle penetration for UEs that are present in the vehicles.

Advantages of Mobile IAB are reducing/eliminating the vehicle penetration loss (specially at high frequency), and reducing/eliminating group handover.

In most use cases, mobile IAB is expected to be mounted on public transport vehicles and to move to a large extent in a pre-determined route. The figure below shows one such mobile IAB mounted on a bus travelling on a route that is covered by 4 different parent IAB nodes (parent 1, 2, 3, 4). The parent nodes backhaul their traffic through 2 donor nodes (donor X,Y).

FIG. 1 illustrates a mobile IAB-node which involves Intra-Donor, Inter-Donor (same CU (Centralized Unit)), and Inter CU.

An IAB node has an IAB-DU (Distributed Unit) that provides access to UEs around it and an IAB-MT (Mobile Termination) that provides a backhaul connection of the IAB node to its parent(s) and the rest of the network. The parent IAB nodes consist of IAB-DUs that provide access to UEs and the mobile IAB present in their coverage. IAB-nodes also consist of an IAB-MT that backhauls its traffic together with traffic from the mobile IAB node. Finally, the two donor nodes consist of DU (Distributed Unit) that provides access and CU (Centralized Unit) that is connected to the core network. The CUs in both donor nodes maintain a F1 connection to IAB-DUs under it.

When the mobile IAB node moves from one geographical area to the next, it passes through different areas covered by various cells of stationary parent nodes.

Next, mIAB-node mobility procedure is discussed.

In general, 3GPP assumes that the mIAB-DU migration between different donor-CUs will be realized by providing a second logical mIAB-DU in an mIAB node (IAB-DU2), that will establish F1 connection to the target donor CU for mIAB-DU migration (IAB-donor-CU2). Then, the UEs served by the mIAB-node will be handed over from a cell of mIAB-DU1 controlled by source donor CU (CU1) to a cell of mIAB-DU2 controlled by target donor CU (CU2). The two cells reside on the same physical IAB-node but they each have a separate F1 connection to IAB-donor-CU1 and IAB-donor-CU2, respectively, see FIG. 2. After UEs are handed over between the mIAB-DU1 and mIAB-DU2, the 1st connection between the mIAB-DU1 and IAB-donor-CU1 is released.

FIG. 2 illustrates a UE handover between cells pertaining to different logical IAB-DUs connected to separate CUs.

Next, random access procedure in a 4-step RA type is discussed.

The 4-step RA type has been used in 4G LTE and is also the baseline for 5G NR. The principle of this procedure in NR is shown in FIG. 3.

### Step 1: Preamble Transmission

The UE randomly selects a Random Access (RA) preamble (PREAMBLE_INDEX) corresponding to a selected SS/PBCH block, and transmits the preamble on the PRACH occasion mapped by the selected SS/PBCH block. When the gNB detects the preamble, it estimates the Timing Advance (TA) the UE should use in order to obtain UL synchronization at the gNB.

### Step 2: RA Response (RAR)

The gNB sends a RA response (RAR) including the TA, the TC-RNTI (temporary identifier) to be used by the UE, a Random Access Preamble identifier that matches the transmitted PREAMBLE_INDEX and a grant for Msg3. The UE expects the RAR and thus, monitors PDCCH addressed to RA-RNTI to receive the RAR message from the gNB until the configured RAR window (ra-ResponseWindow) has expired or until the RAR has been successfully received.

From 3GPP TS38.321: “The MAC entity may stop ra-ResponseWindow (and hence monitoring for Random Access Response(s)) after successful reception of a Random Access Response containing Random Access Preamble identifiers that matches the transmitted PREAMBLE_INDEX.”

### Step 3: “Msg3” (UE ID or UE-Specific C-RNTI)

In Msg3 the UE transmits its identifier (UE ID, or more exactly the initial part of the 5G-TMSI) for initial access or if it is already in RRC_CONNECTED or RRC_INACTIVE mode and needs to e.g. re-synchronize, its UE-specific RNTI. If the gNB cannot decode Msg3 at the granted UL resources, it may send a DCI addressed to TC-RNTI for retransmission of Msg3. HARQ retransmission is requested until the UEs restart the random access procedure from step 1 after reaching the maximum number of HARQ retransmissions or until Msg3 can be successfully received by the gNB.

### Step 4: “Msg4” (Contention Resolution)

In Msg4 the gNB responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously.

For Msg4 reception, the UE monitors TC-RNTI (if it transmitted its UE ID in Msg3) or C-RNTI (if it transmitted its C-RNTI in Msg3).

FIG. 3 illustrates a 4-step RACH procedure.

Next, random access procedure in a 2-step RA type is discussed.

The 2-step RA type gives much shorter latency than the ordinary 4-step RA. In the 2-step RA the preamble and a message corresponding to Msg3 (msgA PUSCH) in the 4-step RA can, depending on configuration, be transmitted in two subsequent slots. The msgA PUSCH is sent on a resource dedicated to the specific preamble. This means that both the preamble and the Msg3 face contention but contention resolution in this case means that either both preamble and Msg 3 are sent without collision or both collide. The 2-step RA procedure is depicted in FIG. 4.

Upon successful reception msgA, the gNB will respond with a msgB. The msgB may be either a “successRAR”, “fallbackRAR or “Back off”. The content of msgB has been agreed as seen below. It is noted in particular that fallbackRAR provides a grant for a Msg3 PUSCH that identifies resources in which the UE should transmit the PUSCH, as well as other information.

Note: The notations “msgA” and “MsgA” are used interchangeably herein to denote message A. Similarly, the notations “msgB” and “MsgB” are used interchangeably herein to denote message B.

FIG. 4 illustrates 2-step RA.

The possibility to replace the 4-step message exchange by a 2-step message exchange would lead to reduced RA latency. On the other hand, the 2-step RA will consume more resources since it uses contention-based transmission of the data. This means that the resources that are configured for the data transmission may often be unused. Another difference is that 2-step RA operated without a timing advance (TA) since there is no feedback from gNB on how to adjust the uplink synchronization before the data payload is transmitted in MsgA PUSCH.

If both the 4-step and 2-step RA are configured in a cell on shared PRACH resources (and for the UE), the UE will choose its preamble from one specific set if it wants to do a 4-step RA, and from another set if it wants to do a 2-step RA. Hence a preamble partition is done to distinguish between 4-step and 2-step RA when shared PRACH resources are used. Alternatively, the PRACH configurations are different for the 2-step and 4-step RA procedure, in which case it can be deduced from where the preamble transmission is done if the UE is doing a 2-step or 4-step procedure.

In 3GPP Rel-16 2-step RA type procedure, UEs are informed of the potential time-frequency resources where they may transmit MsgA PRACH and MsgA PUSCH via higher layer signaling from the network. PRACH is transmitted in periodically recurring RACH occasions (‘ROs’), while PUSCH is transmitted in periodically recurring PUSCH occasions (‘POs’). PUSCH occasions are described in MsgA PUSCH configurations provided by higher layer signaling. Each MsgA PUSCH configuration defines a starting time of the PUSCH occasions which is measured from the start of a corresponding RACH occasion. Multiple PUSCH occasions may be multiplexed in time and frequency in a MsgA PUSCH configuration, where POs in an OFDM symbol occupy a given number of PRBs and are adjacent in frequency, and where POs occupy ‘L’ contiguous OFDM symbols. POs multiplexed in time in a MsgA PUSCH configuration may be separated by a configured gap ‘G’ symbols long. The start of the first occupied OFDM symbol in a PUSCH slot is indicated via a start and length indicator value (‘SLIV’). The MsgA PUSCH configuration may comprise multiple contiguous PUSCH slots, each slot containing the same number of POs. The start of the first PRB relative to the first PRB in a bandwidth part (BWP) is also given by the MsgA PUSCH configuration. Moreover the modulation and coding scheme (MCS) for MsgA PUSCH is also given by the MsgA PUSCH configuration.

Each PRACH preamble maps to a PUSCH occasion and a DMRS port and/or a DMRS port-scrambling sequence combination according to a procedure given in 3GPP TS 38.213. This mapping allows a gNB to uniquely determine the location of the associated PUSCH in time and frequency as well as the DMRS port and/or scrambling from the preamble selected by the UE.

There currently exist certain challenge(s). To support IAB node mobility, the Mobile IAB (mIAB), the specifications need to support inter-CU migration of both the mIAB-MT's RRC connection and the co-located mIAB-DU's F1AP connection, and the inter-donor handover of the UEs served by the mIAB node. This is commonly referred to as the full migration.

Full migration can roughly be divided into these stages: inter-donor mIAB-MT handover; optionally, setting up partial migration, i.e., the migration of F1 traffic of the mIAB-DU; and inter-donor migration of the mIAB-DU by setting up a second logical mIAB-DU that establishes an F1 connection with the target donor CU. Inter-donor migration of the mIAB-DU is followed by the inter-donor UE handover between the two logical mIAB-DUs.

The last step where the UE needs to perform handover would be time consuming; few enhancements that has been proposed in this area is to use RACH-less handover. Since, the UE are physically located in the same place (inside the bus), the timing advance is considered to be same and hence UE may skip msg1 and msg2. This procedure has been applied before for example; for NB-IoT stationary UE; where UL grant resources can be preconfigured (preconfigured uplink resources (PUR)) and UE may assume the last TA to be valid and can skip msg1 and msg2 and can initiate directly via msg3. It is expected that the NB-IoT stationary UE will access the same gNB.

However, in the context of mobile IAB, the issue is that there will be a new logical IAB node which will in fact have to be physically separate in terms of different antenna panels/elements beam forming then the 1st logical DU as both the DUs are expected to operate together momentarily. Hence, the RACH-Less HO as specified previously for LTE cannot be applied directly to mobile-IAB.

### SUMMARY

Some embodiments disclosed herein are directed to a method performed by a user equipment, UE, for performing handover. The method includes receiving a handover command from a network and determining whether a random access channel, RACH-less criteria is satisfied. The method further includes initiating RACH-less handover a target cell based on when the RACH-less criteria is satisfied, else, initiating RACH based handover to the target cell based on when the RACH-less criteria is not satisfied.

Some other embodiments disclosed herein are directed to a method performed by a mobile-integrated access and backhaul, IAB, serving centralized unit, CU, node for facilitating user equipment, UE, handover. The method includes indicating to a UE whether random access procedure needs to be performed when a handover procedure is initiated towards a target cell.

Certain embodiments may provide one or more of the technical advantage(s). Potential advantages of various embodiments includes enabling RACH less HO for UEs served by mobile IA, enabling UE to update TA, and/or provisioning of mapping of beams between two logical DUs.

Other methods implemented by UEs and network nodes and corresponding UEs and networks will be or become apparent to one with skill in the art upon review of the following drawings and detailed description. It is intended that all such additional methods and corresponding UEs and network nodes be included within this description, be within the scope of the present inventive subject matter, and be protected by the accompanying claims. Moreover, it is intended that all embodiments disclosed herein can be implemented individually or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 illustrates a mobile IAB-node which involves Intra-Donor, Inter-Donor (same CU (Centralized Unit)), and Inter CU;

FIG. 2 illustrates a UE handover between cells pertaining to different logical IAB-DUs connected to separate CUs;

FIG. 3 illustrates a 4-step RACH procedure;

FIG. 4 illustrates 2-step RA;

FIG. 5 is a flowchart of operations that can be performed by a UE in accordance with some embodiments of the present disclosure;

FIG. 6 is a flowchart of operations that can be performed by a mobile-IAB serving CU node in accordance with some embodiments of the present disclosure;

FIG. 7 illustrates an example of a communication system in accordance with some embodiments;

FIG. 8 illustrates a UE in accordance with some embodiments;

FIG. 9 illustrates a network node in accordance with some embodiments;

FIG. 10 is a block diagram of a host, which may be an embodiment of the host of FIG. 7, in accordance with various aspects described herein;

FIG. 11 is a block diagram illustrating a virtualization environment in which functions implemented by some embodiments may be virtualized; and

FIG. 12 illustrates a communication diagram of a host communicating via a network node with a UE over a partially wireless connection in accordance with some embodiments.

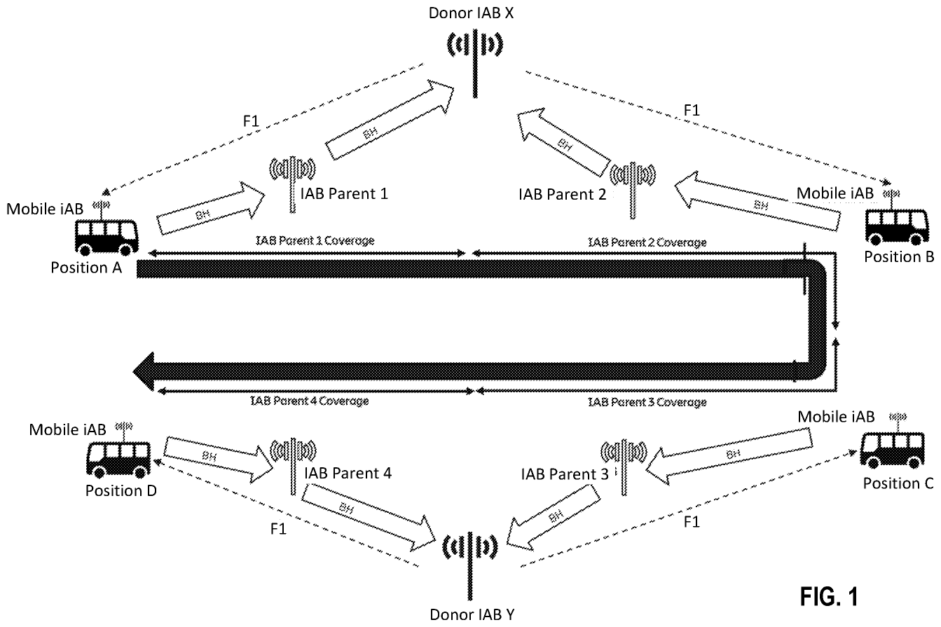

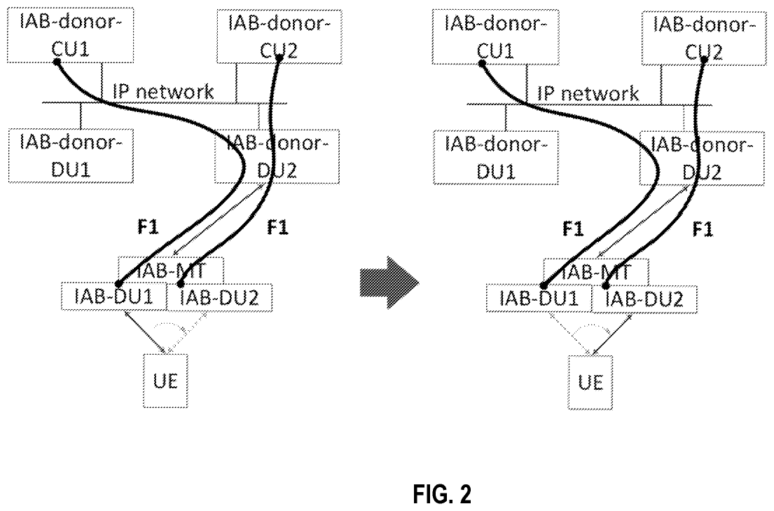

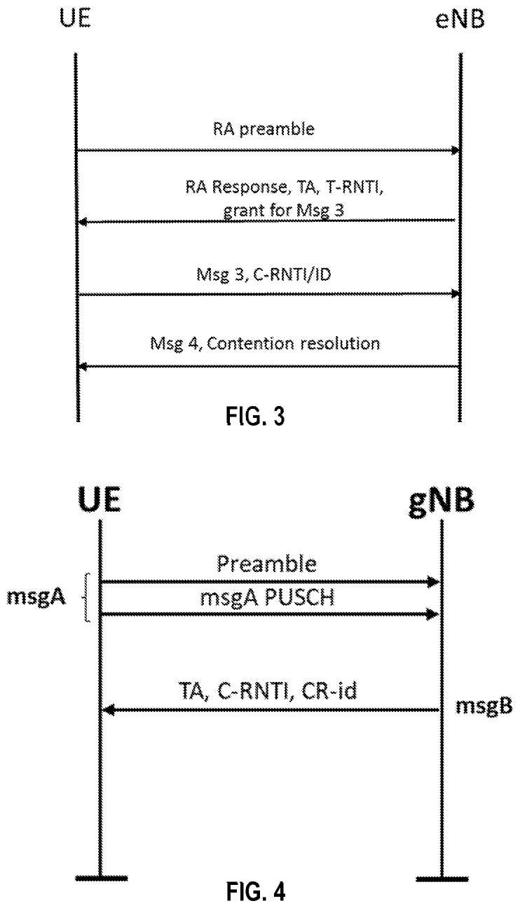

### DETAILED DESCRIPTION

Certain aspects of embodiments presently disclosed may provide solutions to these or other challenges. Various embodiments are directed to how the handover procedure as part of inter-CU migration can be optimized when it comes to RACH-less handover and other related procedure, especially for following cases.

Some embodiments are directed to criteria for a UE to decide whether to pursue RACH based HO or RACH-Less HO. For example, upon receiving handover command (RRC Reconfiguration) msg, the UE decides whether RACH Less HO is possible or not. If the TAT timer is valid for more than defined duration, it may consider proceeding with RACH less; else it would fall back to msg1. TA value storage and UE Time alignment timer (TAT) behavior. The TAT governs whether UE can assume TA is valid or not. The TA is considered valid as long as TAT does not expire.

Some embodiments are directed to signaling to receive mapping beams between the two logical DUs. Beam mapping from logical DU1 to Logical DU2. The UE may be in synchronization signal block (ssb) beam index1 in logical DU1; and this UE has to be handover to an equivalent ssb beam in logical DU2. Mapping may need to be provided.

Some embodiments are directed to Signaling to receive any TA offsets that UE needs to apply. The UL Resource provisioning to send msg3, especially for the case of Conditional Handover (CHO).

Certain embodiments may provide one or more of the following technical advantage(s). Potential advantages of various embodiments includes enabling RACH less HO for UEs served by mobile IA, enabling UE to update TA, and/or provisioning of mapping of beams between two logical DUs.

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

Some embodiments of the present disclosure are directed to a scenario where a mobile IAB node is mounted in a vehicle (in the inside or outside part of it) and one or several UEs should connect to the mobile IAB only when located inside the vehicle (e.g., a bus).

The terms “m-IAB”, “mobile IAB” and “m-IAB node” are used interchangeably.

The terms “m-IAB”, “mobile IAB” and “m-IAB node” are used interchangeably.

The terms mobile IAB-MT and mIAB-MT are used interchangeably.

The terms mobile IAB-DU and mIAB-DU are used interchangeably.

The terms “CU”, “donor CU” and “donor node” are used interchangeably.

The notation “NG/S1 interface” means “NG interface or S1 interface”. Similar meaning is meant for “X2/Xn interface”.

The terminology “UE connected to a mobile IAB” characterizes a UE that is in the coverage provided by the mobile IAB node.

The following embodiments are written in the context of NR but can be applied without any loss of meaning also for other radio access technologies that can be used by a mobile IAB node.

Various operational embodiments of a UE are now discussed.

In a first embodiment, a UE served by mobile IAB cell determines whether to initiate a handover procedure that indicates either performing a random access procedure (RACH HO) or not performing a random access procedure (RACH-less HO).

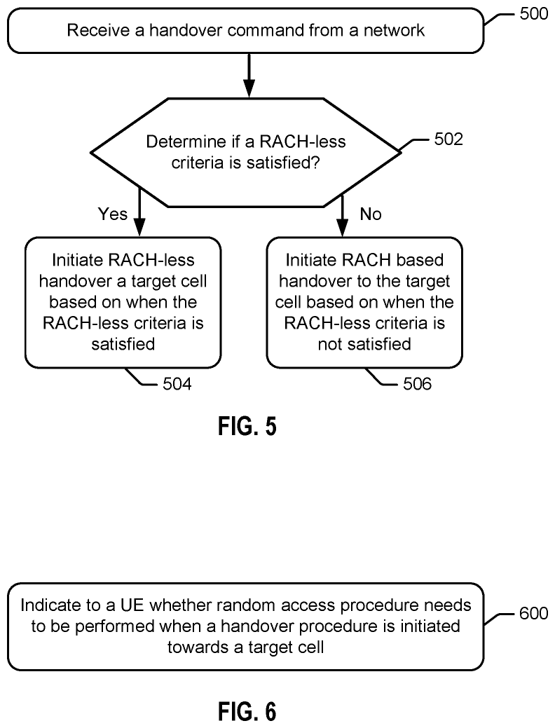

FIG. 5 is a flowchart of operations that can be performed by a UE in accordance with some embodiments of the present disclosure.

In some of these embodiments, a method performed by a UE for performing handover. The method includes receiving 500 a handover command from a network. The method also includes determining 502 whether a RACH-less criteria is satisfied. The method also includes initiating 504 RACH-less handover a target cell based on when the RACH-less criteria is satisfied. Else, initiating 506 RACH based handover to the target cell based on when the RACH-less criteria is not satisfied.

According to this, whether RACH procedure needs to be performed or not during HO can be determined by the UE according to an explicit indication from the network. Also, whether RACH procedure needs to be performed or not during HO can be determined by the UE according to an implicit indication from the network and this indication implies that one or more of the following criteria are considered.

The UL Grant Resources are already available by operation of CHO or RRC Reconfiguration msg as part of HO command.

In some embodiments, the RACH-less criteria is determined to be satisfied based on determining UL grant resources have been provided in a cell handover (CHO) message or a RRC reconfiguration message as part of the handover command.

The time alignment on the UE is still valid for the target cell. In some embodiments, the RACH-less criteria is determined to be satisfied based on determining a TAT of the UE will not expire within a defined duration.

This implies that the timer alignment timer (TAT) is running and is not going to expire within the expected duration of the HO completion.

UE receives the command/configuration from network (NW) to retain its TA and restart its TAT. In some embodiments, the RACH-less criteria is determined to be satisfied based on determining the UE has received a command from the network to retain a TA and restart a TAT.

The UE is aware of which beam needs to synchronize on the target cell. In some embodiments, the RACH-less criteria is determined to be satisfied based on determining the UE has received a message defining a beam to use at the target cell.

This means that UE and network need to be aware on which beam to be used after the HO procedure is complete. In this case, which beam to use should be the same at the UE and target cell, otherwise there is a beam misalignment.

In a second embodiment, a UE served by a mobile IAB cell receives by the network which beam in the new logical DU (i.e., target cell) to use.

In these embodiments, the method further includes receiving, from a network, a defined beam in the target cell to use. The method also further includes initiating the handover using the defined beam.

The UE receives this information as part of system information broadcast or as part of handover procedure via RRC Reconfiguration message. In some embodiments, the beam in the target cell to use is obtained from part of one of a system information broadcast or part of handover procedure via a RRC reconfiguration message.

In another alternative, which beam to be used in a candidate target cell is pre-configured at the UE. In some embodiments, the beam in the target cell to use is pre-configured in the UE.

In one example, “beam” here means the SSB-index to be used at the target cell.

In another example, “beam” here means the TCI state ID to be used at the target cell.

In another example, “beam” here means the TCI state configuration to be used at the target cell.

In the third embodiment, a UE served by a mobile-IAB cell receives TA information to be used in a target cell by the network in case an HO is triggered to that target cell. In these embodiments, the method further includes receiving an updated timing advance, TA, information from the network to be used in a target cell after handover. The UE receives this information as part of system information broadcast as part of handover procedure via RRC Reconfiguration message. In an alternative, which beam to be used in a candidate target cell is pre-configured at the UE.

In one example, the UE receives an absolute TA value and it will start to apply this new value when an HO procedure is initiated to that target cell.

In another example, the UE receives an indication to keep its current TA when an HO is initiated to that target cell.

In another example, the UE receives an indicated to “keep and adjust” its current TA when an HO is initiated to that target cell. In this case the UE will further receive also an offset value that the UE should apply to its current TA value when an HO is initiated to that target cell. The offset value can be a positive or negative value based on whether the UE needs to increase or decrease its current TA value.

In another example, the UE determines whether to keep its current TA or adjust its current TA, or perform RACH procedure because no valid TA is available. In this case the UE may perform a pre-compensation of the TA based on the propagation delay calculated on the target cell when e.g., an HO procedure is initiated to that target cell.

In some embodiments, the method further includes one of: applying a TA value, from the TA information, when a handover is initiated to the target cell; receiving from the network an indication to keep a current TA value, and using the current TA value when a handover is initiated to the target cell; receiving from the network a TA offset, and adjusting the current TA value using the TA offset when the handover is initiated to the target cell; and pre-compensating the current TA value based on a propagation delay calculated for the target cell when the handover is initiated to the target cell.

In a fourth embodiment, the UE served by a mobile IAB cell receives UL grant resources to be used when an HO is initiated towards a target cell and no RACH procedure needs to be performed. In some embodiments, the method also includes receiving uplink, UL, grant resources from the network to be used in a target cell after the handover. The RACH-less criteria is determined to be satisfied based on receiving the uplink grant recourses. The UE receives this information as part of system information broadcast as part of handover procedure via RRC Reconfiguration message. In another alternative, which beam to be used in a candidate target cell is pre-configured at the UE.

In one example, the UE receives UL grant resources within a configuration that has been generated by the target cell to which the HO procedure is initiated.

In another example, the UE receives UL grant resources in advance, meaning that these are provided by the source cell, and the UE will start to use these resources only when an HO is initiated towards that target cell. In this case, it is implied that the source cell and target cell need to coordinate because the UL grant resources are given by the target cell to the source cell.

In a fifth embodiment, the information received by the UE in the previous embodiment are received directly from the source cell, or are received within a configuration generated by the target cell when an HO is initiated to that target cell. In some embodiments, the UL grant resources are received from a source cell or received from a configuration by the target cell when the handover is initiated to the target cell.

Embodiments related to a mobile-IAB serving CU node (also called a source CU) are now discussed.

In the first embodiment, a mobile-IAB serving CU node indicates to the UE whether random access procedure needs to be performed when a HO procedure is initiated towards a target CU node (target CU, or target cell).

FIG. 6 is a flowchart of operations that can be performed by a mobile-IAB serving CU node in accordance with some embodiments of the present disclosure.

Some of these embodiments are directed to a method performed by a mobile-IAB serving CU node for facilitating UE handover. The method includes indicating 600 to a UE whether random access procedure needs to be performed when a handover procedure is initiated towards a target cell.

The indication can be provided explicitly or implicitly. In case of an implicit indication, the serving CU node provides criteria to UEs served by mobile-IAB cell for use to determine whether to proceed with RACH Less HO or RACH based HO. In some embodiments, the indicating to the UE whether random access procedure needs to be performed when a handover procedure is initiated towards a target cell, includes providing a RACH-less criteria to the UE for determining whether to use RACH-less or RACH based handover. The criteria can include one or more of the following.

First, the UL grant resources to be used when the HO procedure is completed in the target cell. In some embodiments, the RACH-less criteria indicates for the UE to determine the RACH-less criteria is satisfied based on when UL grant resources have been provided to the UE in a CHO message or a RRC reconfiguration message as part of the handover command.

Second, TA information to the used in the target cell once that the HO procedure towards that target cell is completed. In some embodiments, the RACH-less criteria indicates for the UE to determine the RACH-less criteria is satisfied based on when a TAT of the UE will not expire within a defined duration.

Third, the beam on which the UE should start to operate when the HO procedure towards that target cell is completed. In some embodiments, the RACH-less criteria indicates for the UE to determine the RACH-less criteria is satisfied based on when the UE has received a command from the network to retain a TA and restart a TAT.

Fourth, in some embodiments, the RACH-less indicates for the UE to determine the RACH-less criteria is satisfied based on when the UE has received a message defining a beam to use at the target cell.

In the second embodiment, a mobile-IAB serving CU node indicates to the UE which beam in the new logical DU (i.e., target cell) to use. In these embodiments, the method also includes indicating to the UE a defined beam in the target cell for the UE to use for handover.

The serving CU may transmit this information as part of system information broadcast or as part of handover procedure via RRC Reconfiguration message. In some embodiments, the beam in the target cell to use is pre-configured in the UE.

In another alternative, which beam to be used in a candidate target cell is pre-configured at the UE

In one example, “beam” here means the SSB-index to be used at the target cell.

In another example, “beam” here means the TCI state ID to be used at the target cell.

In another example, “beam” here means the TCI state configuration to be used at the target cell.

In the third embodiment, a mobile-IAB serving CU node transmits TA information to the UE to be used in a target cell in case an HO is triggered to that target cell. In these embodiments, the method further includes receiving an updated TA information from the network to be used in a target cell after handover.

The mobile-IAB serving CU node transmits this information as part of system information broadcast as part of handover procedure via RRC Reconfiguration message. In another alternative, transmitted TA information, such as which beam to be used in a candidate target cell, is pre-configured at the UE.

In one example, the mobile-IAB serving CU node transmits an absolute TA value and it will start to apply this new value when an HO procedure is initiated to that target cell.

In another example, the mobile-IAB serving CU node transmits an indication to keep its current TA when an HO is initiated to that target cell.

In another example, the mobile-IAB serving CU node transmits an indicated to “keep and adjust” its current TA when an HO is initiated to that target cell. In this case the UE will further receive also an offset value that the UE should apply to its current TA value when an HO is initiated to that target cell. The offset value can be a positive or negative value based on whether the UE needs to increase or decrease its current TA value.

In another example, the mobile-IAB serving CU node transmits an indication to the UE to indicate that the UE should determine itself on whether to keep its current TA or adjust its current TA, or perform RACH procedure because no valid TA is available. In this case the UE may perform a pre-compensation of the TA based on the propagation delay calculated on the target cell when e.g., an HO procedure is initiated to that target cell.

In some embodiments, the method further includes one of: applying a TA value, from the TA information, when a handover is initiated to the target cell; receiving from the network an indication to keep a current TA value, and using the current TA value when a handover is initiated to the target cell; receiving from the network a TA offset, and adjusting the current TA value using the TA offset when the handover is initiated to the target cell; and pre-compensating the current TA value based on a propagation delay calculated for the target cell when the handover is initiated to the target cell.

In a fourth embodiment, the mobile-IAB serving CU node transmits UL grant resources to be used when an HO is initiated towards a target cell and no RACH procedure needs to be performed. In some embodiments, the method further includes receiving uplink, UL, grant resources from the network to be used in a target cell after the handover. The RACH-less criteria is determined to be satisfied based on receiving the uplink grant recourses.

The mobile-IAB serving CU node transmits these information as part of system information broadcast as part of handover procedure via RRC Reconfiguration message. In another alternative, which beam to be used in a candidate target cell is pre-configured at the UE.

In one example, the mobile-IAB serving CU node transmits UL grant resources within a configuration that has been generated by the target cell to which the HO procedure is initiated.

In one example, the mobile-IAB serving CU node transmits UL grant resources in advance, meaning that these are provided by the source cell, and the UE will start to use these resources only when an HO is initiated towards that target cell. In this case is implied that the source cell and target cell needs to coordinated as the UL grant resources are given by the target cell to the source cell, after an explicit request from the source cell.

In a fifth embodiment, the information transmitted by the mobile-IAB serving CU node in the previous embodiment are transmitted by the mobile-IAB node target CU (target CU, target cell) instead. In this case, the mobile-IAB serving CU node will explicitly request one or more of the information that are described in the previous embodiment from the mobile-IAB node target CU. This means that the mobile-IAB node target CU, when preparing the HO command (RRC reconfiguration) to be sent to the UE it will also include all the necessary information to indicate to the UE on whether a random access procedure needs to be performed or not.

In these embodiments, the UL grant resources are received from a source cell or received from a configuration by the target cell when the handover is initiated to the target cell

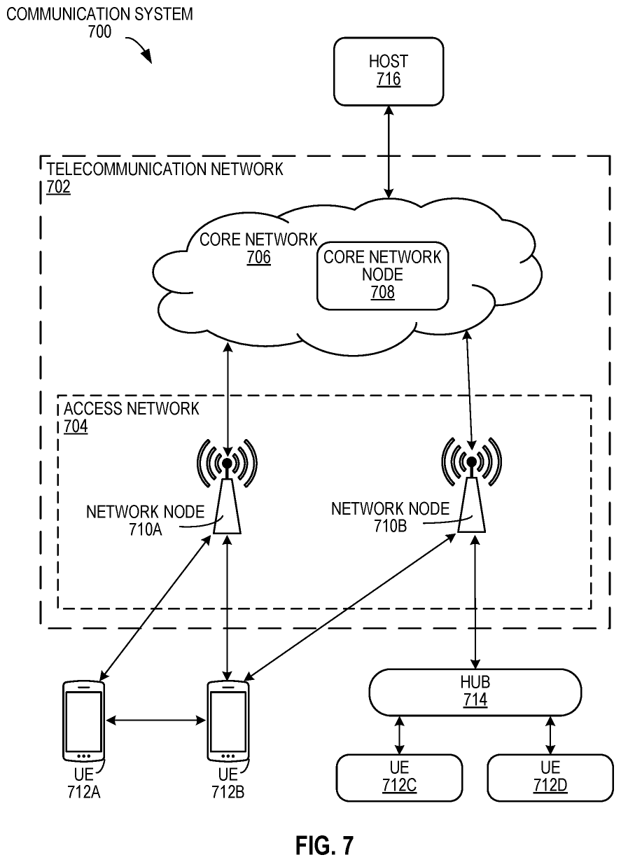

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

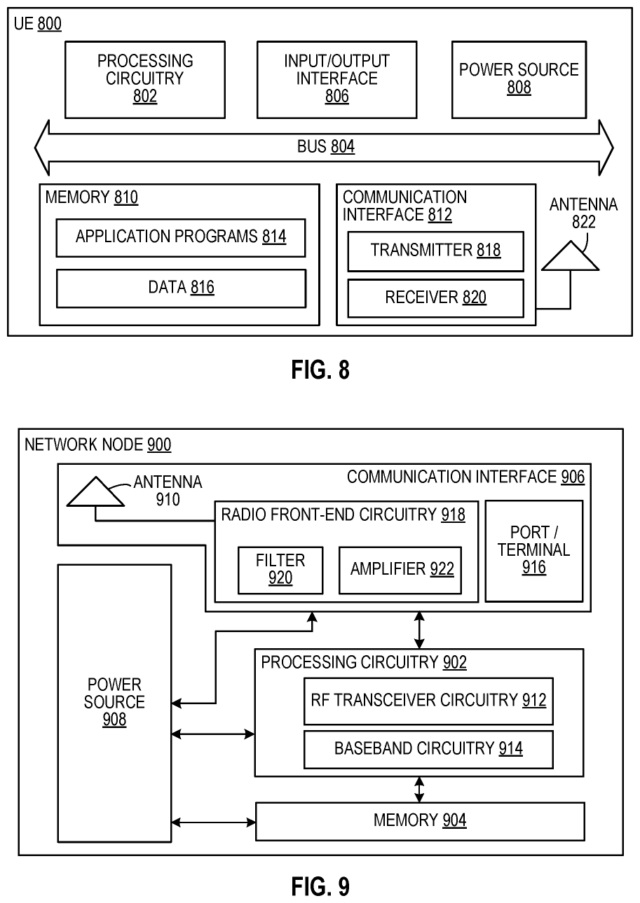

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

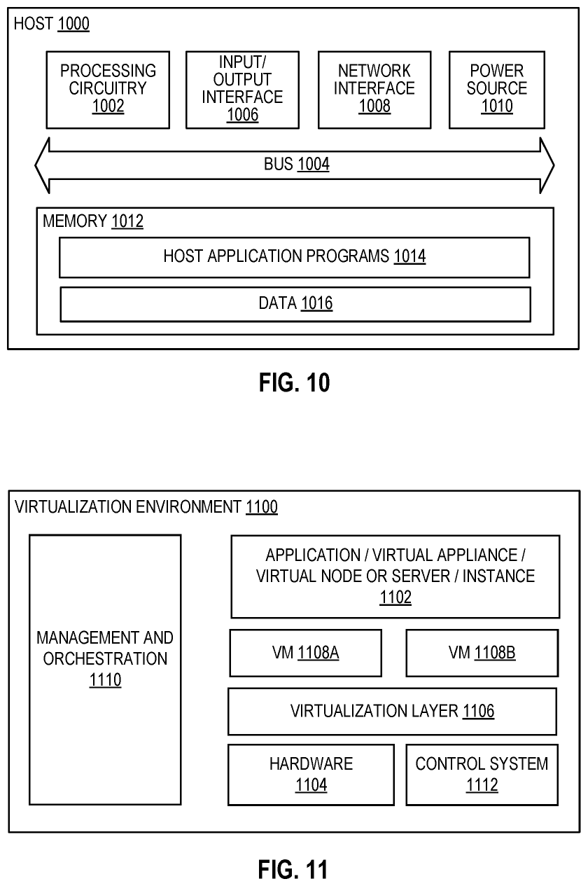

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

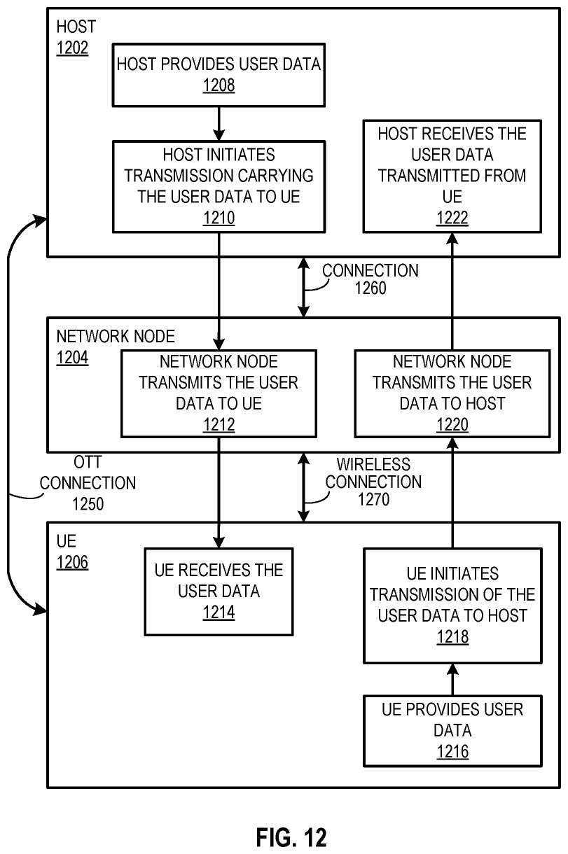

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve the effectiveness of handover and conserve resources that are utilized for handover of UEs between cells of one or more radio network nodes. In accordance with some embodiments, a UE may more quickly perform handover to a target cell, which may benefit OTT services by, for example, enabling reduced user waiting time and/or better responsiveness of communications, reducing radio resource utilization and thereby enabling relaxed restriction on file size, and extend UE battery life.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### a Non-Exclusive Listing of Embodiments According to Some Other Embodiments of the Present Disclosure is Provided Below:

### Group A Embodiments

1. A method performed by a user equipment, UE, for performing handover, the method comprising:
   receiving (500) a handover command from a network;
   determining (502) whether a random access channel, RACH-less criteria is satisfied; and
   initiating (504) RACH-less handover a target cell based on when the RACH-less criteria is satisfied,
   else, initiating (506) RACH based handover to the target cell based on when the RACH-less criteria is not satisfied.
2. The method of Embodiment 1, wherein the RACH-less criteria is determined to be satisfied based on determining uplink, UL, grant resources have been provided in a cell handover, CHO, message or a radio resource control, RRC, reconfiguration message as part of the handover command.
3. The method of any of Embodiments 1 to 2, wherein the RACH-less criteria is determined to be satisfied based on determining a time alignment timer, TAT, of the UE will not expire within a defined duration.
4. The method of any of Embodiments 1 to 3, wherein the RACH-less criteria is determined to be satisfied based on determining the UE has received a command from the network to retain a timing advance, TA, and restart a time alignment timer, TAT.
5. The method of any of Embodiments 1 to 4, wherein the RACH-less criteria is determined to be satisfied based on determining the UE has received a message defining a beam to use at the target cell.
6. The method of any of Embodiments 1 to 5, further comprising:
   receiving, from a network, a defined beam in the target cell to use; and
   initiating the handover using the defined beam.
7. The method of Embodiment 6, wherein the beam in the target cell to use is obtained from part of one of a system information broadcast or part of handover procedure via a radio resource control, RRC, reconfiguration message.
8. The method of Embodiment 6, wherein the beam in the target cell to use is pre-configured in the UE.
9. The method of any of Embodiments 1 to 8, further comprising:
   receiving an updated timing advance, TA, information from the network to be used in a target cell after handover.
10. The method of Embodiment 9, further comprising one of:
   applying a TA value, from the TA information, when a handover is initiated to the target cell;
   receiving from the network an indication to keep a current TA value, and using the current TA value when a handover is initiated to the target cell;
   receiving from the network a TA offset, and adjusting the current TA value using the TA offset when the handover is initiated to the target cell; and
   pre-compensating the current TA value based on a propagation delay calculated for the target cell when the handover is initiated to the target cell.
11. The method of any of Embodiments 1 to 10, further comprising:
   receiving uplink, UL, grant resources from the network to be used in a target cell after the handover,
   wherein the RACH-less criteria is determined to be satisfied based on receiving the uplink grant recourses.
12. The method of any of Embodiment 1 to 10, wherein the UL grant resources are received from a source cell or received from a configuration by the target cell when the handover is initiated to the target cell.

### Group B Embodiments

1. A method performed by a mobile-integrated access and backhaul, IAB, serving centralized unit, CU, node for facilitating user equipment, UE, handover, the method comprising:
   indicating (600) to a UE whether random access procedure needs to be performed when a handover procedure is initiated towards a target cell.
2. The method of Embodiment 1, wherein the indicating to the UE whether random access procedure needs to be performed when a handover procedure is initiated towards a target cell, comprises:
   providing a random access channel, RACH-less criteria to the UE for determining whether to use RACH-less or RACH based handover.
3. The method of Embodiment 2, wherein the RACH-less criteria indicates for the UE to determine the RACH-less criteria is satisfied based on when uplink, UL, grant resources have been provided to the UE in a cell handover, CHO, message or a radio resource control, RRC, reconfiguration message as part of the handover command.
4. The method of any of Embodiments 2 to 3, wherein the RACH-less criteria indicates for the UE to determine the RACH-less criteria is satisfied based on when a time alignment timer, TAT, of the UE will not expire within a defined duration.
5. The method of any of Embodiments 2 to 4, wherein the RACH-less criteria indicates for the UE to determine the RACH-less criteria is satisfied based on when the UE has received a command from the network to retain a timing advance, TA, and restart a time alignment timer, TAT.
6. The method of any of Embodiments 2 to 5, wherein the RACH-less indicates for the UE to determine the RACH-less criteria is satisfied based on when the UE has received a message defining a beam to use at the target cell.
7. The method of any of Embodiments 1 to 6, the method further including:
   indicating to the UE a defined beam in the target cell for the UE to use for handover.
8. The method of Embodiment 7, wherein the defined beam to be used by the UE is transmitted from part of one of a system information broadcast or part of handover procedure via a radio resource control, RRC, reconfiguration message.
9. The method of any of Embodiments 1 to 8, further comprising:
   transmitting timing advance, TA, information to the UE to be used by the UE at the target cell.
10. The method of Embodiment 9, further comprising one of:
   transmitting to a UE a TA value, of the TA information, when a handover is initiated to the target cell;
   transmitting to a UE an indication to keep a current TA value, and using the current TA value when a handover is initiated to the target cell;
   transmitting to a UE a TA offset, and adjusting the current TA value using the TA offset when the handover is initiated to the target cell; and
   transmitting to a UE an indication to pre-compensate the current TA value based on a propagation delay calculated for the target cell when the handover is initiated to the target cell.
11. The method of any of Embodiments 1 to 10, further comprising:
   transmitting uplink, UL, grant resources to the UE to be used by the UE in a target cell after the handover,
   wherein the RACH-less criteria indicates for the UE to determine the RACH-less criteria is satisfied based on when the uplink grant recourses have been provided to the UE.
12. The method of any of Embodiments 1 to 10, wherein the indicating to the UE whether random access procedure needs to be performed when a handover procedure is initiated towards a target cell, comprises:
   communicating with a target cell to initiate transmission of uplink, UL, grant resources to the UE to be used by the UE in the target cell after the handover, and
   wherein the RACH-less criteria indicates for the UE to determine the RACH-less criteria is satisfied based on when the uplink grant recourses have been provided to the UE.

### Group C Embodiments

1. A user equipment, UE, for performing handover, comprising:
   processing circuitry configured to perform any of the steps of any of the Group A Embodiments; and
   power supply circuitry configured to supply power to the processing circuitry.
2. A mobile-integrated access and backhaul, IAB, serving centralized unit, CU, node for user equipment, UE, handover, the mobile-IAB serving CU node comprising:
   processing circuitry configured to perform any of the steps of any of the Group B Embodiments;
   power supply circuitry configured to supply power to the processing circuitry.
3. A user equipment, UE for performing handover, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A Embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
4. A host configured to operate in a communication system to provide an over-the-top, OTT, service, the host comprising:
   processing circuitry configured to provide user data; and
   a network interface configured to initiate transmission of the user data to a mobile-integrated access and backhaul, IAB, serving centralized unit, CU, node in a cellular network for transmission to a user equipment, UE, the IAB serving CU node having a communication interface and processing circuitry, the processing circuitry of the IAB serving CU node configured to perform any of the operations of any of the Group B Embodiments to transmit the user data from the host to the UE.
5. The host of Embodiment 4, wherein:
   the processing circuitry of the host is configured to execute a host application that provides the user data; and
   the UE comprises processing circuitry configured to execute a client application associated with the host application to receive the transmission of user data from the host.
6. A method implemented in a host configured to operate in a communication system that further includes a mobile-integrated access and backhaul, IAB, serving centralized unit, CU, node and a user equipment, UE, the method comprising:
   providing user data for the UE; and
   initiating a transmission carrying the user data to the UE via a cellular network comprising the IAB serving CU node, wherein the IAB serving CU node performs any of the operations of any of the Group B Embodiments to transmit the user data from the host to the UE.
7. The method of Embodiment 6, further comprising, at the IAB serving CU node, transmitting the user data provided by the host for the UE.
8. The method of any of Embodiments 6 to 7, wherein the user data is provided at the host by executing a host application that interacts with a client application executing on the UE, the client application being associated with the host application.
9. A communication system configured to provide an over-the-top, OTT, service, the communication system comprising:
   a host comprising:
   processing circuitry configured to provide user data for a user equipment, UE, the user data being associated with the over-the-top service; and
   a network interface configured to initiate transmission of the user data toward a cellular mobile-integrated access and backhaul, IAB, serving centralized unit, CU, node for transmission to the UE, the IAB serving CU node having a communication interface and processing circuitry, the processing circuitry of the IAB serving CU node configured to perform any of the operations of any of the Group B Embodiments to transmit the user data from the host to the UE.
10. The communication system of Embodiment 9, further comprising:
   the IAB serving CU node; and/or
   the UE.
11. A host configured to operate in a communication system to provide an over-the-top, OTT, service, the host comprising:
   processing circuitry configured to initiate receipt of user data; and
   a network interface configured to receive the user data from a mobile-integrated access and backhaul, IAB, serving centralized unit, CU, node in a cellular network, the IAB serving CU node having a communication interface and processing circuitry, the processing circuitry of the IAB serving CU node configured to perform any of the operations of any of the Group B Embodiments to receive the user data from a user equipment, UE, for the host.
12. The host of Embodiment 11, wherein:
   the processing circuitry of the host is configured to execute a host application that receives the user data; and
   the host application is configured to interact with a client application executing on the UE, the client application being associated with the host application.
13. The host of the any of Embodiments 11 to 12, wherein the initiating receipt of the user data comprises requesting the user data.
14. A method implemented by a host configured to operate in a communication system that further includes a mobile-integrated access and backhaul, IAB, serving centralized unit, CU, node and a user equipment, UE, the method comprising:
   at the host, initiating receipt of user data from the UE, the user data originating from a transmission which the IAB serving CU node has received from the UE, wherein the IAB serving CU node performs any of the steps of any of the Group B Embodiments to receive the user data from the UE for the host.
15. The method of Embodiment 14, further comprising at the IAB serving CU node, transmitting the received user data to the host.
16. A host configured to operate in a communication system to provide an over-the-top, OTT, service, the host comprising:
   processing circuitry configured to provide user data; and
   a network interface configured to initiate transmission of the user data to a cellular network for transmission to a user equipment, UE, wherein the UE comprises a communication interface and processing circuitry, the communication interface and processing circuitry of the UE being configured to perform any of the operations of any of the Group A Embodiments to receive the user data from the host.
17. The host of Embodiment 16, wherein the cellular network further includes a mobile-integrated access and backhaul, IAB, serving centralized unit, CU, node configured to communicate with the UE to transmit the user data to the UE from the host.
18. The host of any of Embodiments 15 to 16, wherein:
   the processing circuitry of the host is configured to execute a host application, thereby providing the user data; and
   the host application is configured to interact with a client application executing on the UE, the client application being associated with the host application.
19. A method implemented by a host operating in a communication system that further includes a mobile-integrated access and backhaul, IAB, serving centralized unit, CU, node and a user equipment, UE, the method comprising:
   providing user data for the UE; and
   initiating a transmission carrying the user data to the UE via a cellular network comprising the IAB serving CU node, wherein the UE performs any of the operations of any of the Group A Embodiments to receive the user data from the host.
20. The method of Embodiment 19, further comprising:
   at the host, executing a host application associated with a client application executing on the UE to receive the user data from the host application.
21. The method of any of Embodiments 19 to 20, further comprising:
   at the host, transmitting input data to the client application executing on the UE, the input data being provided by executing the host application,
   wherein the user data is provided by the client application in response to the input data from the host application.
22. A host configured to operate in a communication system to provide an over-the-top, OTT, service, the host comprising:
   processing circuitry configured to provide user data; and
   a network interface configured to initiate transmission of the user data to a cellular network for transmission to a user equipment, UE, wherein the UE comprises a communication interface and processing circuitry, the communication interface and processing circuitry of the UE being configured to perform any of the steps of any of the Group A Embodiments to transmit the user data to the host.
23. The host of Embodiment 22, wherein the cellular network further includes a mobile-integrated access and backhaul, IAB, serving centralized unit, CU, node configured to communicate with the UE to transmit the user data from the UE to the host.
24. The host of any of Embodiments 22 to 23, wherein:
   the processing circuitry of the host is configured to execute a host application, thereby providing the user data; and
   the host application is configured to interact with a client application executing on the UE, the client application being associated with the host application.
25. A method implemented by a host configured to operate in a communication system that further includes a mobile-integrated access and backhaul, IAB, serving centralized unit, CU, node and a user equipment, UE, the method comprising:
   at the host, receiving user data transmitted to the host via the IAB serving CU node by the UE, wherein the UE performs any of the steps of any of the Group A Embodiments to transmit the user data to the host.
26. The method of Embodiment 25, further comprising:
   at the host, executing a host application associated with a client application executing on the UE to receive the user data from the UE.
27. The method of any of Embodiments 25 to 26, further comprising:
   at the host, transmitting input data to the client application executing on the UE, the input data being provided by executing the host application, wherein the user data is provided by the client application in response to the input data from the host application.

### Abbreviations

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 1x RTT | CDMA2000 1x Radio Transmission Technology |
| 3GPP | 3rd Generation Partnership Project |
| 5G | 5th Generation |
| 6G | 6^{th} Generation |
| ABS | Almost Blank Subframe |
| ARQ | Automatic Repeat Request |
| AWGN | Additive White Gaussian Noise |
| BCCH | Broadcast Control Channel |
| BCH | Broadcast Channel |
| CA | Carrier Aggregation |
| CC | Carrier Component |
| CCCH SDU | Common Control Channel SDU |
| CDMA | Code Division Multiplexing Access |
| CGI | Cell Global Identifier |
| CIR | Channel Impulse Response |
| CP | Cyclic Prefix |
| CPICH | Common Pilot Channel |
| CPICH | Ec/No CPICH Received energy per chip divided by the power density |
| | in the band |
| CQI | Channel Quality information |
| C-RNTI | Cell RNTI |
| CSI | Channel State Information |
| DCCH | Dedicated Control Channel |
| DL | Downlink |
| DM | Demodulation |
| DMRS | Demodulation Reference Signal |
| DRX | Discontinuous Reception |
| DTX | Discontinuous Transmission |
| DTCH | Dedicated Traffic Channel |
| DUT | Device Under Test |
| E-CID | Enhanced Cell-ID (positioning method) |
| eMBMS | evolved Multimedia Broadcast Multicast Services |
| E-SMLC | Evolved-Serving Mobile Location Centre |
| ECGI | Evolved CGI |
| eNB | E-UTRAN NodeB |
| ePDCCH | Enhanced Physical Downlink Control Channel |
| E-SMLC | Evolved Serving Mobile Location Center |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| HARQ | Hybrid Automatic Repeat Request |
| HO | Handover |
| HSPA | High Speed Packet Access |
| HRPD | High Rate Packet Data |
| LOS | Line of Sight |
| LPP | LTE Positioning Protocol |
| LTE | Long-Term Evolution |
| MAC | Medium Access Control |
| MAC | Message Authentication Code |
| MBSFN | Multimedia Broadcast multicast service Single Frequency Network |
| MBSFN ABS | MBSFN Almost Blank Subframe |
| MDT | Minimization of Drive Tests |
| MIB | Master Information Block |
| MME | Mobility Management Entity |
| MSC | Mobile Switching Center |
| NPDCCH | Narrowband Physical Downlink Control Channel |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PCFICH | Physical Control Format Indicator Channel |
| PDCCH | Physical Downlink Control Channel |
| PDCP | Packet Data Convergence Protocol |
| PDP | Profile Delay Profile |
| PDSCH | Physical Downlink Shared Channel |
| PGW | Packet Gateway |
| PHICH | Physical Hybrid-ARQ Indicator Channel |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUSCH | Physical Uplink Shared Channel |
| RACH | Random Access Channel |
| QAM | Quadrature Amplitude Modulation |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RRC | Radio Resource Control |
| RRM | Radio Resource Management |
| RS | Reference Signal |
| RSCP | Received Signal Code Power |
| RSRP | Reference Symbol Received Power OR |
| | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSS | Secondary Synchronization Signal |
| TDD | Time Division Duplex |
| TDOA | Time Difference of Arrival |
| TOA | Time of Arrival |
| TSS | Tertiary Synchronization Signal |
| TTI | Transmission Time Interval |
| UE | User Equipment |
| UL | Uplink |
| USIM | Universal Subscriber Identity Module |
| UTDOA | Uplink Time Difference of Arrival |
| WCDMA | Wide CDMA |
| WLAN | Wide Local Area Network |

### REFERENCES

[1] RP-221815, WID on Mobile IAB for NR, 3GPP TSG RAN #96, Budapest, Hungary, June 2022
[2] 3GPP TR 22.839 V18.1.0 (2021 December)

### APPENDIX

3GPP TSG-RAN WG2 #121-bis-e R2-230xxxx
Online Meeting, 17-26 Apr. 2023
Agenda Item: 8.12.x
Source: Ericsson
Title: Issues on supporting RACH-less for mobile IAB
Document for: Discussion, Decision

### 1 INTRODUCTION

In the RAN2 #119-e meeting, the following agreement has been reached regarding the support of RACH-less handover for mobile IAB.

| | |
|---|---|
| ⇒ | R2 assumes RACH-less procedure may be considered for on-board |
| | RRC_CONNECTED UEs, which are to be handed over together with |
| | the mobile IAB-node (would depend also on the assumptions for UL |
| | synch). |

In this contribution we will address the feasibility of supporting RACH-less handover for mobile IAB.

### 2 DISCUSSION

When the mobile IAB changes its donor-CU (changed e.g., during a handover leaving the old CU service area), this has also an impact on UEs served by the mobile IAB. This is mainly because some of the parameter of the cell that is hosted on the mobile IAB may change and because the new CU may decide to reconfigure even the DU part of the mobile IAB (in case of full migration).

However, one of the aspects to be considered is that, from the perspective of a UE served by the mobile IAB, even if the mobile IAB changes its donor CU, a UE that is served by the mobile IAB does not really change any cell as is still physically located within the coverage of the mobile IAB.
Observation 1 Even if the mobile IAB changes its donor CU, a UE that is served by the mobile IAB does not really change any cell as it is still physically located within the coverage of the mobile IAB.

According to this, in principle some RRC procedures that normally happen during a handover procedure can be avoided. This will bring benefits in terms of less connectivity interruption but also less signalling overhead for the UE and the network. In fact, since the cell in which a UE is connected does not really change, most likely the TA (timing advance) value that the UE is using for the UL synchronization can still fully be reused. However, this needs to be confirmed by RAN1.
Observation 2 In case a mobile IAB changes its donor CU, a UE that is served by the mobile IAB does not really change the physical cell and thus the assumption is that the TA used by the UE may still be valid. However, this needs to be confirmed by RAN1.

Even if it could be feasible for a UE to keep it current TA when the mobile IAB changes its donor CU, maintaining the TA is only one of the pieces needed to perform a RACH-less handover. In fact, two more issues to be discussed are how the UE will receive the UL grant for the first UL transmission to the new target cell and how the beam alignment between the UE and the target cell works.
Observation 3 In case a mobile IAB changes its donor CU, if RACH-less handover for the UEs needs to be supported, is not clear how the UL grant is assigned.
Observation 4 In case a mobile IAB changes its donor CU, if RACH-less handover for the UEs needs to be supported, is not clear to which beam the UE will perform the first UL transmission or DL reception with the target cell.

Given these open issues, it is worth noticing that RAN1 does not have any TU allocated for the mobile IAB WI, and that RAN2 has limited number of TUs in the upcoming meeting to finish its work.
Observation 5 RAN1 does not have any TU allocated for the mobile IAB WI, and that RAN2 has limited number of TUs in the upcoming meeting to work on a possible RACH-less solution for mobile IAB.

Therefore, we propose:
Proposal 1 In case of a group handover of the UE served by the mobile IAB, RACH-less handover is not supported.

### 3 CONCLUSION

In the previous sections we made the following observations:
Observation 1 . . . Even if the mobile IAB changes its donor CU, a UE that is served by the mobile IAB does not really change any cell as it is still physically located within the coverage of the mobile IAB.
Observation 2 . . . In case a mobile IAB changes its donor CU, a UE that is served by the mobile IAB does not really change the physical cell and thus the assumption is that the TA used by the UE may still be valid. However, this needs to be confirmed by RAN1.
Observation 3 . . . In case a mobile IAB changes its donor CU, if RACH-less handover for the UEs needs to be supported, is not clear how the UL grant is assigned.
Observation 4 . . . In case a mobile IAB changes its donor CU, if RACH-less handover for the UEs needs to be supported, is not clear to which beam the UE will perform the first UL transmission or DL reception with the target cell.
Observation 5 . . . RAN1 does not have any TU allocated for the mobile IAB WI, and that RAN2 has limited number of TUs in the upcoming meeting to work on a possible RACH-less solution for mobile IAB.

Based on the discussion in the previous sections we propose the following:
Proposal 1 . . . In case of a group handover of the UE served by the mobile IAB, RACH-less handover is not supported.

1. A method performed by a user equipment, UE, for performing handover, the method comprising:
receiving a handover command from a network;
determining whether a random access channel, RACH-less criteria is satisfied; and
initiating RACH-less handover a target cell based on when the RACH-less criteria is satisfied,
else, initiating RACH based handover to the target cell based on when the RACH-less criteria is not satisfied.

2. The method of claim 1, wherein the RACH-less criteria is determined to be satisfied based on determining uplink, UL, grant resources have been provided in a cell handover, CHO, message or a radio resource control, RRC, reconfiguration message as part of the handover command.

3. The method of claim 1, wherein the RACH-less criteria is determined to be satisfied based on determining a time alignment timer, TAT, of the UE will not expire within a defined duration.

4. The method of claim 1, wherein the RACH-less criteria is determined to be satisfied based on determining the UE has received a command from the network to retain a timing advance, TA, and restart a time alignment timer, TAT.

5. The method of claim 1, wherein the RACH-less criteria is determined to be satisfied based on determining the UE has received a message defining a beam to use at the target cell.

6. The method of claim 1, further comprising:
receiving, from a network, a defined beam in the target cell to use; and
initiating the handover using the defined beam.

7. The method of claim 6, wherein the beam in the target cell to use is obtained from part of one of a system information broadcast or part of handover procedure via a radio resource control, RRC, reconfiguration message.

8. The method of claim 6, wherein the beam in the target cell to use is pre-configured in the UE.

9. The method of claim 1, further comprising:
receiving an updated timing advance, TA, information from the network to be used in a target cell after handover.

10. The method of claim 9, further comprising one of:
applying a TA value, from the TA information, when a handover is initiated to the target cell;
receiving from the network an indication to keep a current TA value, and using the current TA value when a handover is initiated to the target cell;
receiving from the network a TA offset, and adjusting the current TA value using the TA offset when the handover is initiated to the target cell; and
pre-compensating the current TA value based on a propagation delay calculated for the target cell when the handover is initiated to the target cell.

11. The method of claim 1, further comprising:
receiving uplink, UL, grant resources from the network to be used in a target cell after the handover,
wherein the RACH-less criteria is determined to be satisfied based on receiving the uplink grant recourses.

12. The method of claim 1, wherein the UL grant resources are received from a source cell or received from a configuration by the target cell when the handover is initiated to the target cell.

13. A method performed by a mobile-integrated access and backhaul, IAB, serving centralized unit, CU, node for facilitating user equipment, UE, handover, the method comprising:
indicating to a UE whether random access procedure needs to be performed when a handover procedure is initiated towards a target cell.

14. The method of claim 13, wherein the indicating to the UE whether random access procedure needs to be performed when a handover procedure is initiated towards a target cell, comprises:
providing a random access channel, RACH-less criteria to the UE for determining whether to use RACH-less or RACH based handover.

15. The method of claim 14, wherein the RACH-less criteria indicates for the UE to determine the RACH-less criteria is satisfied based on when uplink, UL, grant resources have been provided to the UE in a cell handover, CHO, message or a radio resource control, RRC, reconfiguration message as part of the handover command.

16. The method of claim 14, wherein the RACH-less criteria indicates for the UE to determine the RACH-less criteria is satisfied based on when a time alignment timer, TAT, of the UE will not expire within a defined duration.

17. The method of claim 14, wherein the RACH-less criteria indicates for the UE to determine the RACH-less criteria is satisfied based on when the UE has received a command from the network to retain a timing advance, TA, and restart a time alignment timer, TAT.

18. The method of claim 14, wherein the RACH-less indicates for the UE to determine the RACH-less criteria is satisfied based on when the UE has received a message defining a beam to use at the target cell.

19. The method of claim 13, the method further including:
indicating to the UE a defined beam in the target cell for the UE to use for handover.

20. The method of claim 19, wherein the defined beam to be used by the UE is transmitted from part of one of a system information broadcast or part of handover procedure via a radio resource control, RRC, reconfiguration message.

21-27. (canceled)
